(19) United States
(12) Patent Application Publication
(10) Pub. No.: US 2010/0273093 A1
(43) Pub. Date: Oct. 28, 2010

(54) CATALYST PARTICLE SIZE CONTROL WITH ORGANIC PIGMENTS

(75) Inventors: Mark K. Debe, Stillwater, MN (US); Jason A. Bender, Woodbury, MN (US); David A. Sowatzke, Spring Valley, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/766,304

(22) Filed: Apr. 23, 2010

Related U.S. Application Data
(60) Provisional application No. 61/172,111, filed on Apr. 23, 2009.

(51) Int. Cl. H01M 4/92; H01M 4/02

(52) U.S. Cl. 429/524; 429/523

(57) ABSTRACT

A fuel cell catalyst is provided comprising nanostructured elements comprising microstructured support whiskers bearing a thin film of nanoscopic catalyst particles, where the thin film of nanoscopic catalyst particles is made by alternating application of first layers comprising catalyst material, such as platinum or a platinum alloy, and second layers comprising a vacuum sublimable organic molecular solid, such as an aromatic organic pigments such as perylene red or a pthalocyanine

### CROSS REFERENCE TO RELATED APPLICATION

This application claims the benefit of U.S. Provisional Patent Application No. 61/172111, filed Apr. 23, 2009, the disclosure of which is incorporated by reference herein in its entirety.

This invention was made with Government support under Cooperative Agreement DE-FG36-07G017007 awarded by DOE. The Government has certain rights in this invention.

### FIELD OF THE DISCLOSURE

This disclosure relates to nanostructured thin film (NSTF) catalysts comprising interspersed organic materials, which may be useful as fuel cell catalysts.

### BACKGROUND OF THE DISCLOSURE

U.S. Pat. No. 5,879,827, the disclosure of which is incorporated herein by reference, discloses nanostructured elements comprising acicular microstructured support whiskers bearing acicular nanoscopic catalyst particles. The catalyst particles may comprise alternating layers of different catalyst materials which may differ in composition, in degree of alloying or in degree of crystallinity.

U.S. Pat. No. 6,482,763, the disclosure of which is incorporated herein by reference, discloses fuel cell electrode catalysts comprising alternating platinum-containing layers and layers containing suboxides of a second metal that display an early onset of CO oxidation.

U.S. Pat. Nos. 5,338,430, 5,879,828, 6,040,077 and 6,319,293, the disclosures of which are incorporated herein by reference, also concern nanostructured thin film catalysts.

U.S. Pat. Nos. 4,812,352, 5,039,561, 5,176,786, and 5,336,558, the disclosures of which are incorporated herein by reference, concern microstructures.

U.S. Pat. No. 7,419,741, the disclosure of which is incorporated herein by reference, discloses fuel cell cathode catalysts comprising nanostructures formed by depositing alternating layers of platinum and a second layer onto a microstructure support, which may form a ternary catalyst.

U.S. Pat. No. 7,622,217, the disclosure of which is incorporated herein by reference, discloses fuel cell cathode catalysts comprising microstructured support whiskers bearing nanoscopic catalyst particles comprising platinum and manganese and at least one other metal at specified volume ratios and Mn content, where other metal is typically Ni or Co.

### SUMMARY OF THE DISCLOSURE

Briefly, the present disclosure provides a fuel cell catalyst comprising nanostructured elements comprising microstructured support whiskers bearing a thin film of nanoscopic catalyst particles, said thin film of nanoscopic catalyst particles made by alternating application of first and second layers, said first layers comprising catalyst material and said second layers comprising a vacuum sublimable organic molecular solid. In some embodiments, the catalyst material comprises platinum. In some embodiments, the catalyst material comprises an alloy of platinum. In some embodiments, the catalyst material is platinum. In some embodiments, the vacuum sublimable organic molecular solids is selected from the group consisting of aromatic organic pigments. In some embodiments, the vacuum sublimable organic molecular solids is selected from the group consisting of aromatic organic pigments. In some embodiments, the vacuum sublimable organic molecular solids is selected from the group consisting of pthalocyanines and perylenes. In some embodiments, the fuel cell catalyst comprising at least two of the first layers, more typically at least three of the first layers, and in some embodiments at least ten of the first layers. In some embodiments, the fuel cell catalyst comprising at least two of the second layers, more typically at least three of the second layers, and in some embodiments at least ten of the second layers. In some embodiments, the fuel cell catalyst comprising at least two each of the first and second layers, more typically at least three each of the first and second layers, and in some embodiments at least ten each of the first and second layers. In some embodiments, first layers have a planar equivalent thickness of at least 5 Angstroms, in some embodiments at least 10 Angstroms, and in some embodiments at least 15 Angstroms. In some embodiments, first layers have a planar equivalent thickness of less than 2000 Angstroms, in some embodiments less than 500 Angstroms, in some embodiments less than 300 Angstroms, in some embodiments less than 200 Angstroms, in some embodiments less than 100 Angstroms, in some embodiments less than 80 Angstroms, and in some embodiments less than 60 Angstroms. In some embodiments, second layers have a planar equivalent thickness of at least 5 Angstroms, in some embodiments at least 10 Angstroms, and in some embodiments at least 15 Angstroms. In some embodiments, second layers have a planar equivalent thickness of less than 2000 Angstroms, in some embodiments less than 500 Angstroms, in some embodiments less than 300 Angstroms, in some embodiments less than 200 Angstroms, in some embodiments less than 100 Angstroms, in some embodiments less than 80 Angstroms, and in some embodiments less than 60 Angstroms.

In this application:
“membrane electrode assembly” means a structure comprising a membrane that includes an electrolyte, typically a polymer electrolyte, and at least one but more typically two or more electrodes adjoining the membrane;
“nanostructured element” means an acicular, discrete, microscopic structure comprising a catalytic material on at least a portion of its surface;
“nanoscopic catalyst particle” means a particle of catalyst material having at least one dimension equal to or smaller than about 15 nm or having a crystallite size of about 15 nm or less, as measured from diffraction peak half widths of standard 2-theta x-ray diffraction scans;
“thin film of nanoscopic catalyst particles” includes films of discrete nanoscopic catalyst particles, films of fused nanoscopic catalyst particles, and films of nanoscopic catalyst grains which are crystalline or amorphous; typically films of discrete or fused nanoscopic catalyst particles, and most typically films of discrete nanoscopic catalyst particles;
“acicular” means having a ratio of length to average cross-sectional width of greater than or equal to 3;
“discrete” refers to distinct elements, having a separate identity, but does not preclude elements from being in contact with one another;
“microscopic” means having at least one dimension equal to or smaller than about a micrometer;
“planar equivalent thickness” means, in regard to a layer distributed on a surface, which may be distributed unevenly, and which surface may be an uneven surface (such as a layer of snow distributed across a landscape, or a layer of atoms distributed in a process of vacuum deposition), a thickness calculated on the assumption that the total mass of the layer was spread evenly over a plane covering the same area as the projected area of the surface (noting that the projected area covered by the surface is less than or equal to the total surface area of the surface, once uneven features and convolutions are ignored);
“bilayer planar equivalent thickness” means the total planar equivalent thickness of a first layer (as described herein) and the next occurring second layer (as described herein); and
“vacuum sublimable organic molecular solid” means a mixture of compounds or more typically a single compound which is a solid at standard temperature and pressure (25° C. and 1 atmosphere), which is organic and more typically aromatic, and which may be deposited by vacuum sublimation.

It is an advantage of the present disclosure to provide catalysts for use in fuel cells.

### BRIEF DESCRIPTION OF THE DRAWINGS

FIG. 1 is a graph plotting Pt<111> grain size of catalyst as a function of the thickness of catalyst layers applied, for fuel cell catalysts according to the present disclosure, as described in the Examples below.

### DETAILED DESCRIPTION

This disclosure relates to fuel cell catalysts containing platinum (Pt) which can be characterized as having a grain size, a Pt fcc lattice spacing, and surface area of catalyst particles. This disclosure relates to materials used in methods of manipulating grain size, a Pt fcc lattice spacing, and surface area independent of catalyst loading and the resulting catalyst materials.

The size of the catalyst particle is important because it can directly determine the available mass specific surface area (m²/g) of the catalyst and how well the catalyst mass is utilized by its surface reactions. The Pt fcc lattice spacing in an alloy is important because it directly reflects changes in the electronic band structure of the alloy and ultimately the Pt-Pt spacing on the surface that determine how strongly O₂ and OH⁻ adsorb onto the catalyst surface and thereby the resultant kinetic rate for the oxygen reduction reaction. Specifically this disclosure relates to materials used in methods for controlling the catalyst particle or grain size, and lattice parameter, determined from X-ray diffraction, by intermixing layers of the catalyst, such as Pt or Pt alloy, with layers of vacuum sublimable organic molecular solids. This disclosure relates to materials used in methods to obtain a desired grain size, lattice parameter and increased catalyst surface area, independent of catalyst loading, for different atomic ratios of the catalyst/intermixed material. The preferred method for depositing the layers is by vacuum deposition methods, and the preferred catalyst supports are high aspect ratio (>3) structures. This disclosure is particularly relevant to the nanostructured thin film (NSTF) supported catalysts.

NSTF catalysts are highly differentiated from conventional carbon supported dispersed catalysts in multiple ways. The four key differentiating aspects are: 1) the catalyst support is an organic crystalline whisker that eliminates all aspects of the carbon corrosion plaguing conventional catalysts, while facilitating the oriented growth of Pt nanowhiskers (whiskerettes) on the whisker supports; 2) the catalyst coating is a nanostructured thin film rather than an isolated nanoparticle that endows the NSTF catalysts with a ten-fold higher specific activity for oxygen reduction (ORR), the performance limiting fuel cell cathode reaction; 3) the nanostructured thin film morphology of the catalyst coating on the NSTF whisker supports endows the NSTF catalyst with more resistance to Pt corrosion under high voltage excursions while producing much lower levels of per-oxides that lead to premature membrane failure; and 4) the process for forming the NSTF catalysts and support whiskers is an all dry roll-good process that makes and disperses the support whiskers as a monolayer and coats them with catalyst on a moving web, all potentially in a single pass. The disclosures of following patents are incorporated herein by reference: U.S. Pat. No. 7,419,741; U.S. Pat. No. 5,879,827; U.S. Pat. No. 6,040,077; U.S. Pat. No. 5,336,558; U.S. Pat. No. 5,336,558; U.S. Pat. No. 5,336,558; U.S. Pat. No. 6,136,412.

The NSTF catalyst is particularly useful for meeting PEM fuel cell performance and durability requirements with very low loadings of precious metal catalysts. The key issue with any catalyst for any application is to utilize the catalyst mass as effectively as possible. This means increasing the mass specific area (m²/g) so that the ratio of surface area to mass is as high as possible, but without losing specific activity for the key ORR reaction. Absolute activity of a fuel cell electrocatalyst is the product of both the surface area and the specific activity, and for conventional dispersed catalysts specific activity decreases significantly when the mass specific surface area is increased by reducing the particle size. In addition, smaller catalyst particles tend to be more unstable with respect to Pt corrosion and dissolution mechanisms. So there is generally an optimum desired size for conventional dispersed catalysts in the several nanometer range which compromises the gain in surface area with loss of specific activity and durability.

The grain sizes of the nanostructured catalyst film coating formed on the NSTF crystalline organic whiskers are typically larger in size than conventional dispersed Pt/Carbon catalysts, resulting in lower total surface area and mass specific area (m²/g). Reducing the grain size for any given loading is desirable in order to determine the best value that gives optimum surface area while maintaining the fundamentally higher specific activity and stability. Heretofore the grain size of the vacuum deposited (using electron beam evaporation or magnetron sputter deposition) coatings on the NSTF whiskers were controlled by the total catalyst loading on the whisker supports (expressed for example in mg of Pt per cm² of electrode active area) and the surface area of those support whiskers (generally the areal number density and lengths). With this disclosure, we teach how the grain size can be obtained independent of the loading or whisker support. This is achieved by vacuum depositing the catalyst as alternating layers of catalyst metal (e.g. Pt or Pt alloys) and highly stable, vacuum sublimable organic molecular solids, such as metal free phthalocyanine (H₂Pc), copper phthalocyanine (CuPc) or perylene red (PR) the same material comprising the NSTF whiskers.

This disclosure concerns an approach to increasing both the NSTF surface area and specific activity at reduced loadings (<0.25 mg-Pt/cm² total). It is an unexpected result of the current disclosure that the function of one conformal coating material is to directly affect and control the physical properties (e.g. Pt grain sizes and shapes) of the adjacent conformal coating material during deposition of the conformal coatings.

### Examples

All the Examples were made with unalloyed Pt catalyst. Both electron beam evaporation in a CHA-Mark 50 coater and sputtering were used to deposit Pt on the NSTF whisker support films. The former produced 12″×12″ square sheets of material, the latter produced roll-good samples, each coated onto varying lots, but otherwise identical substrates of the NSTF MCTS (microstructured catalyst transfer substrate.) The e-beam deposited Pt is identified as e-Pt, the sputtered Pt as s-Pt in the sample identification list below. Deposition conditions can be found in the references cited above.

Multi-layer samples were fabricated both in the Mark-50 batch coater and a roll-good the sputtering coater, referred to here as P1. The multilayer catalyst samples consist of either just pure Pt coated onto the whiskers in single or multiple passes, or multilayer constructions of Pt alternating with an organic pigment material. Three organic pigment materials were used, viz. PR149 (perylene red, the same pigment materials used for the NSTF whiskers), and copper and metal-free phthalocyanine, CuPc and H₂Pc. The number of alternating layers varied from 1 to a maximum of 37. The individual Pt layer thicknesses varied from 30 Angstroms to 2000 Angstroms, and the organic pigment layer thicknesses varied from 6 Angstroms to 200 Angstroms. To produce the alternating layers of Pt and pigments, the sample substrate was passed alternately in front of the Pt sputtering source or the sublimation source for the pigments during web coating in the P1 coater. For the single sheet batch coating in the Mark 50 coater, the coater was cycled between e-beam evaporation and pigment sublimation (it contained both source types) without breaking vacuum. For most of the samples, the number of Pt layers and the Pt layer thickness was chosen to keep the total Pt loading fixed at a loading of 0.21 mg/cm². For the pure Pt cases the loading was varied up to a maximum of about 0.55 mg/cm².

The catalyst samples were all evaluated by X-ray diffraction (XRD) after the catalysts were transferred to one side of a 30 micron thick piece of NAFION(™) proton exchange membrane as when making an MEA. Techniques were developed to assure alignment in the XRD unit to minimize error in the measured lattice constants. The principal error is due to vertical displacement of the sample, for which 30 microns (approximately the sample thickness) would correlate to a 0.010 Angstrom error in the d-spacing of an (hid) peak. The sample XRD's were used to determine the crystalline phases present, apparent crystallite or grain sizes, d(hkl)-spacings and relative intensity ratios. Data was collected using a Philips APD vertical diffractometer, copper K_{α} radiation, reflection geometry, and proportional detector registry of the scattered radiation. Only the Pt fcc crystalline phase was detected. The apparent crystallite sizes, and d-spacings were determined from the observed diffraction peak angular positions and half-widths using a Pearson VII peak shape model, accounting for α₁/α₂ separation. The background (obtained from a diffraction scan of the Nafion™ “blank” was subtracted prior to profile fitting. For reference bulk Pt, XRD data was used from the literature.

TABLE I
Summary of the sample constructions and X-ray diffraction data.

| | | Number | Layers | Pt | | | | | | | | |
|---|---|---|---|---|---|---|---|---|---|---|---|---|
| | | of | of | Loading | Sample | <hkl> | grain | sizes | (Angs.) | d[hkl] | Lattice | Spacings |
| Sample ID | Sample Construction | Pt | Organic | (mg/cm²) | Set | <111> | <200> | <220> | <311> | d[111] | d[200] | d[220] |
| 589-3 | 30A s-Pt + 17 × | 18 | 17 | 0.11 | 1 | 36 | 32 | 39 | 35 | 2.262 | 1.967 | 1.382 |
| | (30A s-Pt + 30A PR) | | | | | | | | | | | |
| 589-3 | 30A s-Pt + 17 × | 18 | 17 | 0.11 | 2 | 40 | 30 | 26 | 25 | 2.262 | 1.965 | 1.38 |
| | (30A s-Pt + 30A PR) | | | | | | | | | | | |
| MF962 | 36A e-Pt + 3 × | 37 | 36 | 0.031 | 1 | 44 | 36 | 39 | 40 | 2.261 | 1.968 | 1.382 |
| | (36A e-Pt + 50A PR) | | | | | | | | | | | |
| MF963 | 36A e-Pt + 3 × | 37 | 36 | 0.031 | 2 | 30 | — | — | — | 2.257 | | |
| | (36A e-Pt + 50A PR) | | | | | | | | | | | |
| 589-1 | 30A s-Pt + 28 × | 29 | 28 | 0.19 | 1 | 47 | 41 | 40 | 37 | 2.269 | 1.963 | 1.384 |
| | (30A s-Pt + 6A PR) | | | | | | | | | | | |
| 589-1 | 30A s-Pt + 28 × | 29 | 28 | 0.19 | 2 | 48 | 38 | 35 | 37 | 2.266 | 1.963 | 1.384 |
| | (30A s-Pt + 6A PR) | | | | | | | | | | | |
| 591-1 | 30A s-Pt + 33 × | 34 | 33 | 0.21 | 1 | 51 | 46 | 47 | 47 | 2.273 | 1.969 | 1.386 |
| | (30A s-Pt + 30A PR) | | | | | | | | | | | |
| 591-1 | 30A s-Pt + 33 × | 34 | 33 | 0.21 | 2 | 52 | 46 | 45 | 42 | 2.262 | 1.955 | 1.385 |
| | (30A s-Pt + 30A PR) | | | | | | | | | | | |
| MF1022 | 50A e-Pt + 9 × | 10 | 9 | 0.11 | 1 | 53 | 45 | 40 | 38 | 2.256 | 1.953 | 1.38 |
| | (50A e-Pt + 50A CuPc) | | | | | | | | | | | |
| MF1023 | 50A e-Pt + 9 × | 10 | 9 | 0.11 | 2 | 53 | 44 | 49 | 51 | 2.258 | 1.956 | 1.384 |
| | (50A e-Pt + 50A CuPc) | | | | | | | | | | | |
| MF1024 | 50A e-Pt + 9 × | 10 | 9 | 0.11 | 1 | 54 | 47 | 45 | 34 | 2.262 | 1.958 | 1.383 |
| | (50A e-Pt + 50A CuPc)/ | | | | | | | | | | | |
| | 1000 A Mn | | | | | | | | | | | |
| MF1025 | 50A e-Pt + 9 × | 10 | 9 | 0.11 | 2 | 62 | 48 | 52 | 57 | 2.266 | 1.958 | 1.383 |
| | (50A e-Pt + 50A CuPc)/ | | | | | | | | | | | |
| | 1000 A Mn | | | | | | | | | | | |
| MF1027 | 75A e-Pt + 9 × | 10 | 9 | 0.16 | 1 | 64 | 58 | 57 | 55 | 2.259 | 1.956 | 1.383 |
| | (75A e-Pt + 50A H₂Pc) | | | | | | | | | | | |
| MF1026 | 75A e-Pt + 9 × | 10 | 9 | 0.16 | 2 | 66 | 59 | 62 | 52 | 2.262 | 1.957 | 1.384 |
| | (75A e-Pt + 50A H₂Pc) | | | | | | | | | | | |
| MF1021 | 100A e-Pt + 9 × | 10 | 9 | 0.21 | 1 | 77 | 71 | 67 | 66 | 2.261 | 1.956 | 1.385 |
| | (100A e-Pt + 50A CuPc) | | | | | | | | | | | |
| MF1020 | 100A e-Pt + 9 × | 10 | 9 | 0.21 | 2 | 79 | 69 | 63 | 63 | 2.26 | 1.955 | 1.384 |
| | (100A e-Pt + 50A CuPc) | | | | | | | | | | | |
| 589-2 | 125A s-Pt + 7 × | 8 | 7 | 0.21 | 1 | 78 | 59 | 70 | 56 | 2.266 | 1.963 | 1.385 |
| | (125A s-Pt + 25A PR) | | | | | | | | | | | |
| 589-2 | 125A s-Pt + 7 × | 8 | 7 | 0.21 | 2 | 71 | 56 | 55 | 52 | 2.27 | 1.966 | 1.388 |
| | (125A s-Pt + 25A PR) | | | | | | | | | | | |
| MF973 | 250A e-Pt + 3 × | 4 | 3 | 0.21 | 1 | 90 | 73 | 71 | 67 | 2.272 | 1.965 | 1.389 |
| | (250A e-Pt + 50A PR) | | | | | | | | | | | |
| MF973 | 250A e-Pt + 3 × | 4 | 3 | 0.21 | 2 | 93 | 73 | 68 | 63 | 2.265 | 1.961 | 1.387 |
| | (250A e-Pt + 50A PR) | | | | | | | | | | | |
| MF978 | 125A e-Pt + 7 × | 8 | 7 | 0.21 | 1 | 90 | 71 | 71 | 65 | 2.277 | 1.97 | 1.391 |
| | (125A e-Pt + 25A PR) | | | | | | | | | | | |
| MF978 | 125A e-Pt + 7 × | 8 | 7 | 0.21 | 2 | 84 | 70 | 72 | 64 | 2.263 | 1.956 | 1.386 |
| | (125A e-Pt + 25A PR) | | | | | | | | | | | |
| MF1038 | 500A e-Pt + 1 × | 2 | 1 | 0.21 | 1 | 111 | 87 | 87 | 77 | 2.264 | 1.96 | 1.386 |
| | (500A e-Pt + 50A H₂Pc) | | | | | | | | | | | |
| MF1039 | 333A e-Pt + 2 × | 3 | 2 | 0.21 | 1 | 109 | 86 | 82 | 78 | 2.259 | 1.956 | 1.384 |
| | (333A e-Pt + 50A H₂Pc) | | | | | | | | | | | |
| MF986 | 1000A e-Pt over | 1 | 1 | 0.21 | 1 | 114 | 88 | 88 | 81 | 2.267 | 1.965 | 1.388 |
| | 200A H₂Pc) | | | | | | | | | | | |
| MF986 | 1000A e-Pt over | 1 | 1 | 0.21 | 2 | 120 | 94 | 83 | 71 | 2.26 | 1.957 | 1.385 |
| | 200A H₂Pc) | | | | | | | | | | | |
| MF985 | 1000A e-Pt over | 1 | 1 | 0.21 | 1 | 119 | 95 | 94 | 85 | 2.266 | 1.964 | 1.386 |
| | 200A CuPc) | | | | | | | | | | | |
| MF990 | 1 layer of 1000 Angs | 1 | 0 | 0.21 | 1 | 143 | 85 | 99 | 90 | 2.266 | 1.963 | 1.387 |
| | e-Pt | | | | | | | | | | | |
| MF991 | 1 layer of 1000 Angs | 1 | 0 | 0.21 | 1 | 135 | 95 | 91 | 83 | 2.269 | 1.963 | 1.387 |
| | e-Pt | | | | | | | | | | | |
| MF993/992 | 1 layer of 2000 Angs | 1 | 0 | 0.42 | 1 | 168 | 110 | 102 | 89 | 2.264 | 1.961 | 1.387 |
| | e-Pt | | | | | | | | | | | |
| MF994/995 | 1 layer of 1000 Angs | 1 | 0 | 0.21 | 1 | 177 | 107 | 109 | 99 | 2.267 | 1.964 | 1.386 |
| | e-Pt over 750 Ang Mn | | | | | | | | | | | |
| 577-3, 569-3 | 1 layer of 1000 Angs s-Pt | 1 | 0 | 0.21 | 1 | 136 | 107 | 98 | 87 | 2.266 | 1.963 | 1.386 |
| Exp 584-0.2 | 5 layers of 200 Ang s-Pt | 5 | 0 | 0.21 | 1 | 122 | 89 | 85 | 81 | 2.264 | 1.961 | 1.387 |
| Exp 584-0.3 | 7 layers of 200 Ang s-Pt | 7 | 0 | 0.29 | 1 | 122 | 95 | 91 | 81 | 2.266 | 1.963 | 1.388 |
| Exp 584-0.4 | 9 layers of 200 Ang s-Pt | 9 | 0 | 0.34 | 1 | 134 | 98 | 94 | 82 | 2.27 | 1.966 | 1.388 |
| Exp 584-0.5 | 11 layers of 200 Ang s-Pt | 11 | 0 | 0.46 | 1 | 153 | 114 | 104 | 88 | 2.269 | 1.965 | 1.389 |
| Exp 584-0.6 | 13 layers of 200 Ang s-Pt | 13 | 0 | 0.55 | 1 | 166 | 122 | 108 | 94 | 2.267 | 1.964 | 1.389 |
| #4-802 | Bulk Pt Reference, | | | | | | | | | 2.265 | 1.962 | 1.387 |
| | Literature Values | | | | | | | | | | | |

Table I lists the catalyst sample identifier, multilayer construction, total Pt loading, fcc d-spacings for (hkl)=(111), (200), (220, and (311) diffraction peaks, and the grain sizes in Angstroms from the corresponding peak half-widths. XRD data were taken in two different sets over a period of several months, from the same sample types, and are indicated in Table I as set 1 or set 2.

The “Sample Construction” column in Table I uses the following nomenclature. PR refers to PR149 perylene red, CuPc copper phthalocyanine, and H₂Pc refers to metal-free phthalocyanine e-Pt refers to e-beam deposited Pt and s-Pt refers to sputtered Pt. The “Sample Construction” entry describes the layers applied, e.g., “30A s-Pt+17×(30A s-Pt+30A PR)” indicates the sample consisted of a single 30 angstrom layer of sputtered Pt deposited on top of 17 layers, each 30 Angstroms thick, of sputter deposited Pt alternating with 17 layers, each 30 Angstroms thick, of sublimed perylene red. The following Samples are Comparative, since they include Pt but no second layer material: MF990, MF991, MF993/MF992, MF994/MF995, 577-3, 569-3, Exp 584-0.2, Exp 584-0.3, Exp 584-0.4, Exp 584-0.5, Exp 584-0.6, #4-802.

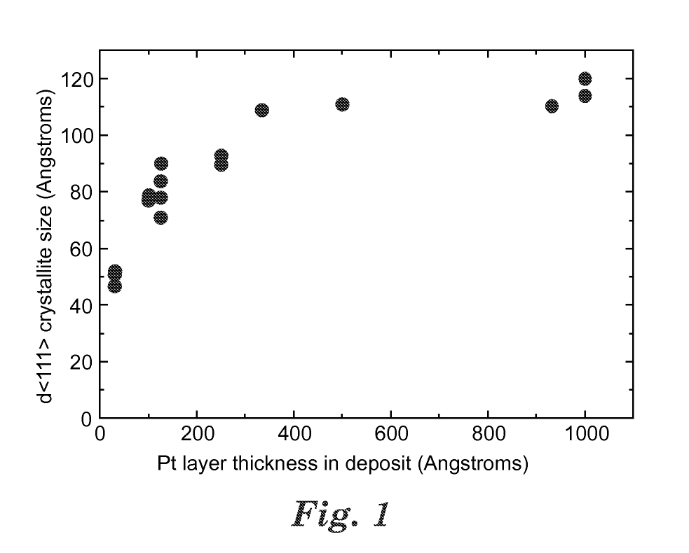

FIG. 1 is a graph plotting the Pt<111> grain size of the catalyst as a function of the thickness of Pt layers applied (alternating with second layers of vacuum sublimable organic molecular solid), for only those samples in Table I having a total Pt loading of 0.21 mg/cm². Thus, FIG. 1 demonstrates that arbitrary Pt grain sizes can be achieved at fixed total Pt loading by controlling the thickness of Pt layers alternated with second layers.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A fuel cell catalyst comprising nanostructured elements comprising microstructured support whiskers bearing a thin film of nanoscopic catalyst particles, said thin film of nanoscopic catalyst particles made by alternating application of first and second layers, said first layers comprising catalyst material and said second layers comprising a vacuum sublimable organic molecular solid.

2. The fuel cell catalyst according to claim 1 where said catalyst material comprises platinum.

3. The fuel cell catalyst according to claim 1 where said catalyst material is an alloy of platinum.

4. The fuel cell catalyst according to claim 1 where said catalyst material is platinum.

5. The fuel cell catalyst according to claim 1 where said vacuum sublimable organic molecular solids is selected from the group consisting of aromatic organic pigments.

6. The fuel cell catalyst according to claim 5 where said vacuum sublimable organic molecular solids is selected from the group consisting of pthalocyanines and perylene red.

7. The fuel cell catalyst according to claim 1 comprising at least two of said first layers.

8. The fuel cell catalyst according to claim 1 comprising at least two of said first layers and at least two of said second layers.

9. The fuel cell catalyst according to claim 1 comprising at least three of said first layers.

10. The fuel cell catalyst according to claim 1 comprising at least two of said first layers and at least two of said second layers.

11. The fuel cell catalyst according to claim 1 wherein said first layers have a planar equivalent thickness of between 5 Angstroms and 2000 Angstroms.

12. The fuel cell catalyst according to claim 1 wherein said first layers have a planar equivalent thickness of between 5 Angstroms and 300 Angstroms.

13. The fuel cell catalyst according to claim 1 wherein said first layers have a planar equivalent thickness of between 5 Angstroms and 200 Angstroms.

14. The fuel cell catalyst according to claim 1 wherein said first layers have a planar equivalent thickness of between 5 Angstroms and 100 Angstroms.

15. The fuel cell catalyst according to claim 1 wherein said first layers have a planar equivalent thickness of between 10 Angstroms and 200 Angstroms.

16. The fuel cell catalyst according to claim 1 wherein said first layers have a planar equivalent thickness of between 10 Angstroms and 100 Angstroms.

17. The fuel cell catalyst according to claim 1 wherein said second layers have a planar equivalent thickness of between 5 Angstroms and 2000 Angstroms.

18. The fuel cell catalyst according to claim 1 wherein said second layers have a planar equivalent thickness of between 10 Angstroms and 300 Angstroms.
